(19) United States
(12) Patent Application Publication
(10) Pub. No.: US 2010/0231028 A1
(43) Pub. Date: Sep. 16, 2010

(54) AERODYNAMIC WHEEL COVERING

(76) Inventor: William W. Brannon, III, Johnson City, TN (US)

Correspondence Address: FOX ROTHSCHILD LLP, 997 Lenox Drive, Bldg. #3, Lawrenceville, NJ, 08648, US

(21) Appl. No.: 12/438,292

(22) PCT Filed: Aug. 27, 2007
(86) PCT No.: PCT/US07/76843

§ 371 Date: Feb. 20, 2009

Related U.S. Application Data
(60) Provisional application No. 60/840,152, filed on Aug. 25, 2006.

(51) Int. Cl. B60B 7/00; B60B 7/02

(52) U.S. Cl. 301/37.22

(57) ABSTRACT

A removable wheel covering to improve the aerodynamic profile of a motor vehicle tire comprising means for fastening the wheel covering to a wheel rim, the rim having a first axis about which the rim is rotatable; means for flexibly adhering the wheel covering to a tire side wall; and an air engaging circular surface that is rotatable about the axis, that is convex with respect to the tire, and that has a diameter that is proximal to the diameter of the tire at the side wall.

### BACKGROUND

1. Field of Invention:

This invention relates to an apparatus for improving the aerodynamic efficiency of a motor vehicle wheel. More specifically, this invention relates to a wheel covering for improving the aerodynamic profile of a motor vehicle wheel.

2. Description of Related Art:

A variety of techniques have been used to improve the fuel efficiency of motor vehicles. Of particular interest to the present invention is aerodynamic profiling (a.k.a. streamlining) wherein the form of the vehicle or one of its components is designed to lessen resistance to air flow while the vehicle is in motion. By increasing the aerodynamic efficiency of a vehicle, the energy expended to propel the vehicle through air is reduced which leads to an increase in fuel efficiency.

One area of aerodynamic inefficiency of conventional vehicles occurs at the vehicle's wheels. For example, the wheels of a semitrailer typically utilize deep rims and are not enclosed in wheel wells. Thus, when the vehicle is in motion, the wheel is subjected to air resistance that exerts a force in a direction opposite to the wheel's direction of movement, which is also the vehicle's direction of movement. As a conventional wheel travels through the air, the air that surrounds the wheel has different velocities and thus, different pressures. The air exerts maximum pressure at a stagnation point on the front of the wheel. The air then flows around the side surfaces of the wheel with an increased velocity and reduced pressure. At some separation point, the air separates from the side surfaces of the wheel and generates a large turbulent flow area behind the wheel. This flow area, which is called the wake, has low pressure. The difference between the high pressure at the front of the wheel and the low pressure behind the wheel slows the wheel and the vehicle down. This is the primary source of drag for the wheel.

All objects moving through air have a thin layer, called the boundary layer, of air surrounding them. The object shapes range from blunt to streamlined. Blunt objects create large wakes behind them that in turn create greater drag. More streamlined objects create a smaller wake and therefore less drag. The surface features on the wheel cause a thin boundary layer of air adjacent to the wheel's outer surface to become turbulent. This turbulence energizes the boundary layer and helps keep it attached to the sides of the wheel longer, thus moving the separation point further backward on the wheel which reduces the size of the wake behind the wheel creating a more streamlined and aerodynamic air flow. As a result, there is a reduction in the area of the wake behind the wheel which increases the pressure behind the wheel, and substantially reduces the aerodynamic drag. It is the surface features on the wheel of the present invention that creates the turbulence in the boundary layer and reduces the aerodynamic drag.

Efforts have been made to reduce the drag around wheels in certain applications, such as bicycles, airplanes, trucks, and cars. For example, US 2004/0135424 (Ording) discloses a light-weight bicycle wheel rim having aerodynamic surfaces to reduce drag. U.S. Pat. No. 5,131,727 (Johnson) discloses a bicycle wheel covering to improve aerodynamic efficiency. Other devices that cover the entire wheel have been proposed for reducing drag have been proposed. For example, U.S. Pat. No. 5,820,203 (Morelli) describes an automobile wheel covering having a fan device that directs the flow of air in order to reduce drag.

However, there remains a need for reducing drag on vehicle wheels, particularly semitrailer wheels, that is economical and easy to apply to existing wheels. The present invention satisfies these and other needs.

### SUMMARY OF THE INVENTION

The present invention improves the aerodynamic efficiency of motor vehicles by streamlining air flow around the vehicle's tires. Accordingly, an objective of the present invention is to provide a smooth surface over the tire in the tire's radial direction.

In a preferred embodiment of the present invention, provided is a wheel covering to improve the aerodynamic profile of a motor vehicle tire that is rotatable about an axis comprising an air engaging surface that is rotatable about the axis; convex with respect to the tire; circular and has a diameter that is proximal to the diameter of the tire at the side wall; fastenable to a tire rim; and adjacent to a tire's outside sidewall crest. Preferably the tire covering is removable from the tire.

In another preferred embodiment, provided is a method for improving the aerodynamic profile of a motor vehicle tire comprising the step of applying a wheel covering to a tire, wherein the wheel covering comprises (a) means for fastening the wheel covering to a wheel rim, the rim having a first axis about which the rim is rotatable; (b) means for flexibly adhering the wheel covering to a tire side wall; and (c) an air engaging circular surface that is rotatable about the axis, that is convex with respect to the tire, and that has a diameter that is proximate to the diameter of the tire at the side wall.

Another objective of the invention is to provide a surface over the tire in the tire's radial direction that produces a narrow layer of turbulent air at the surface. This turbulence energizes the boundary layer and helps keep it attached to the sides of the wheel longer, thus moving the separation point further backwards on the wheel, which in turn, reduces the size of the wake behind the wheel. This reduction in wake creates a more streamlined and aerodynamic air flow which improves fuel efficiency of the vehicle.

In a preferred embodiment of the invention, provided is a wheel covering that is rotatable about an axis comprising an air engaging surface that is rotatable about the axis; convex with respect to the tire; circular and has a diameter that is proximal to the diameter of the tire at the side wall; fastenable to a tire rim; adjacent to a tire's outside sidewall crest; and comprises a plurality of dimples.

### BRIEF DESCRIPTION OF THE DRAWINGS

FIG. 1A shows a cross-sectional view of a wheel without a covering;

FIG. 1B shows a cross-sectional view of a wheel with a covering according to an embodiment of the present invention;

FIG. 2A shows a perspective view of a wheel without a covering; and

FIG. 2B shows a perspective view of wheel with a covering according to an embodiment of the present invention.

### DETAILED DESCRIPTION OF THE PREFERRED EMBODIMENT

The present invention is directed to a wheel covering which improves the aerodynamic efficiency of a motor vehicle wheel. It is expected that the wheel covering of the present invention may be used on any type of wheel, particularly wheels having a tire mounted on a rigid rim. The present invention is particularly well suited for applications such as semitrailers, but may also be practiced with passenger cars, buses, trucks, airplanes, or any other motor vehicle having wheels.

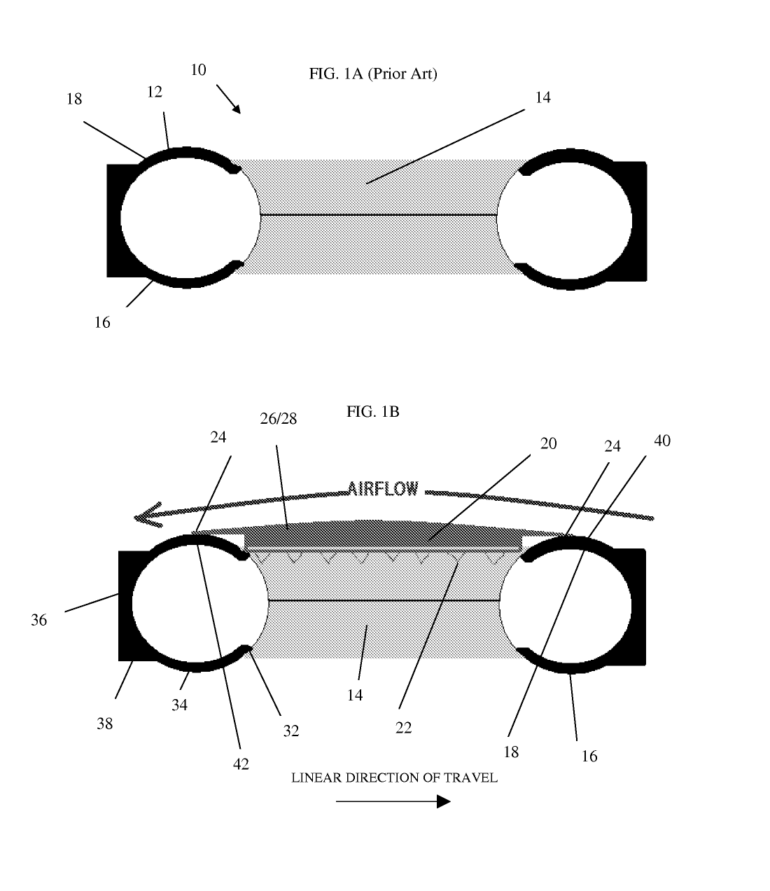

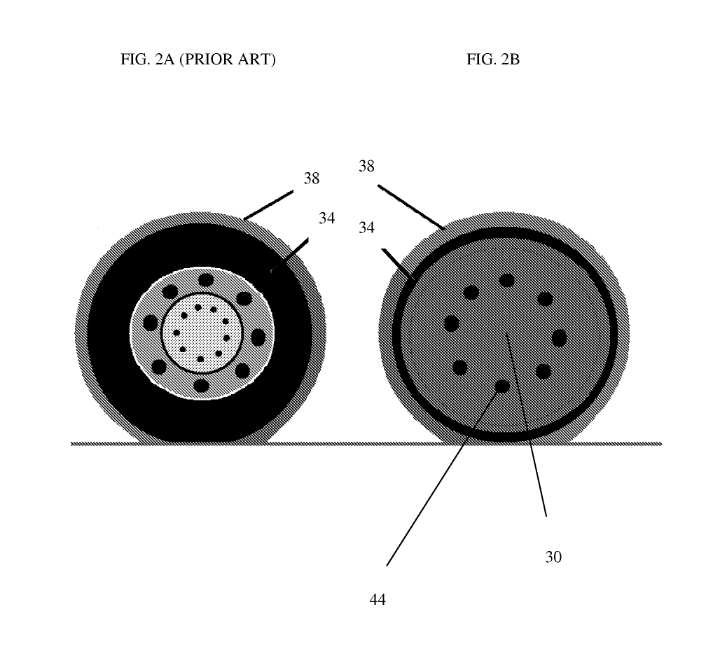

Referring to FIG. 1A, shown is a cross-sectional view of a typical wheel (10) wherein a tire (12) is mounted on a rim (14). The wheel has an inner (16) and outer side (18) relative to the vehicle (not shown). A perspective view of this embodiment is also shown in FIG. 2A. A conventional automobile tire has a circular bead (32) that frictionally fits inside the lip of the rim (14), a sidewall (34), tread (36), and a shoulder (38) that transitions the sidewall into the tread. The tire sidewall comprises a convex annulus surface (40) having a crest at the apex (42) of the surface. The tire is constructed of conventional materials including, for example, synthetic rubber composites, nylon, and steel belts. The rim is constructed of steel, aluminum alloy, or any other suitable material.

FIG. 1B and FIG. 2B show a wheel covering (20) according to present invention wherein the wheel covering (20) is rigidly fastened (22) to the rim (14) and also flexibly biased (24) against the outside sidewall (18) of the tire (12). In this embodiment, the cover comprises a convex (with respect to the rim), circular surface (26) that engages the air flowing around the wheel as the wheel is in linear motion. The air engaging surface (28) shown in FIG. 1B is smooth, but in other embodiments, the surface may be include dimple shaped impressions (44).

For embodiments utilizing dimpled surfaces, the dimpled impressions may be an array of singular sized dimples or, more preferably, may be an array of dimples of multiple sizes. Multiple sizes are preferred in order to fit more dimples onto the surface. The dimpled shaped impression provides two advantages, with the first being aerodynamic, and the second being structural. With respect to the aerodynamic advantages, the covering of dimples on the air engaging surface creates a thin layer of air next to the wheel, i.e., the boundary layer. This boundary layer of air becomes turbulent in its flow patterns over the surface features of the air engaging surfaces. Rather than flowing in smooth continuous layers over the air engaging surface, the dimples cause the air to have a microscopic pattern of fluctuations and randomized flow. This “turbulence” in the boundary layer enables the air flowing around the air engaging surface to better follow the surface of the air engaging surface, and enables the air to travel further along the air engaging surfaces of the wheel. This creates a much smaller wake at the “down stream end” of the wheel. This reduced wake results in a significant reduction in the aerodynamic drag of the wheel. In addition, the use of surface depressions, such as an array of dimpled depressions, can also provide structural advantages to the covering.

The diameter of the cover is proximal to the diameter of the tire at the side wall. Typically, tire sidewalls are constructed so as to form a “bulge” in cross-section. A crest exists at the outermost limit or apex of this bulge. In certain preferred embodiment, the wheel cover adheres to the sidewall at the crest in order to maximize the streamline effect of the cover.

The means for fasting the wheel cover to the rim may be any means known in the art including, for example, clips and threaded fasteners. Preferably the cover is rigidly and firmly attached to the rim so that the wheel cover turns in tandem with the rim. Preferably, the wheel covering is also removably fastened to the rim so that the cover can be easily removed in order to perform maintenance on the wheel, such as a tire rotation or a tire change. The portion of the wheel cover that is secured to the rim is preferably constructed of a rigid material such as a rigid plastic or metal.

The means for adhering the wheel cover to the tire may be any means known in the art, including for example, static charge, friction, chemical bonding, and elastic bias. Preferably, the wheel cover is not rigidly attached to the tire so that the tire may flex and bend independently of the cover. Instead, the cover preferably clings to the tire.

The portion of the wheel covering that adheres to the tire can be constructed of either a flexible material or a rigid material. In certain embodiments, adhesion between the tire and covering is achieve via chemical bonding, such as the bonding produced from a weak adhesive. In other embodiments, adhesion is accomplished via a static charge that develops or is induced between the rubber of the tire and the portion of the cover that contacts the tire. In still other embodiments, adhesion is accomplished by an elastic bias of the wheel cover. For example, a cover may be constructed so that the portion of the cover that contacts the tire is elastic and is biased toward the tire. When the cover is sufficiently secured to the rim, tension is placed on the cover at the point of contact with the tire causing the cover to deform at that point. Since the cover is elastically biased toward the tire, the cover will be held in place until the tension is removed. In still another embodiment, the wheel cover simply forms a friction fit with the tire sidewall.

The air engaging surface may also comprise one or more ventilators to channel air through the wheel. In certain embodiments, the air is channeled from the outside of the wheel to underneath the vehicle, while in other embodiments, the air is channeled from underneath the vehicle to outside the wheel. This directional air flow is desirable in certain applications to cool brake pads and rotors or drums.

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A wheel covering to improve the aerodynamic profile of a motor vehicle tire that is rotatable about an axis comprising an air engaging surface that is:
(a) rotatable about the axis;
(b) convex with respect to the tire;
(c) circular and has a diameter that is proximal to the diameter of the tire at the side wall;
(d) fastenable to a tire rim; and
(e) adjacent to a tire's outside sidewall crest.

2. The wheel covering of claim 1 wherein said covering is biased towards the tire's outside sidewall crest.

3. The wheel covering of claim 1 wherein said covering is in physical contact with the tire's outside sidewall crest.

4. The wheel covering of claim 1 wherein said covering is positioned against the tire's outside sidewall crest.

5. The wheel covering of claim 1 wherein said covering adheres to the tire's outside sidewall crest.

6. The wheel covering of claim 1 wherein adhering to the tire's outside sidewall crest involves a static charge or friction.

7. The wheel covering of claim 1 wherein the wheel covering is fastenable to the wheel rim via a fastener selected from the group consisting of clip-on fasteners and threaded fasteners.

8. The wheel covering of claim 1 wherein the air engaging surface is smooth.

9. The wheel covering of claim 1 wherein the air engaging surface comprises a plurality of dimples.

10. The wheel covering of claim 9 wherein the dimples are regularly spaced apart.

11. The wheel covering of claim 1 wherein the curved surface of the wheel covering comprises one or more ventilators.

12. The wheel covering of claim 11 wherein the ventilators comprise apertures in the wheel covering.

13. A method for improving the aerodynamic profile of a motor vehicle tire comprising the step of applying a wheel covering according to claim 1 to a tire.
